(19) United States
(12) Patent Application Publication
(10) Pub. No.: US 2019/0264640 A1
(43) Pub. Date: Aug. 29, 2019

(54) SIEVE SEAL AND METHOD FOR OPERATION THEREOF

(71) Applicant: ElringKlinger AG, Dettingen-Erms (DE)

(72) Inventors: Thilo Lutz, Dettingen-Erms (DE); Wojtek Kolasinski, Dettingen-Erms (DE); Magnus Reichert, Dettingen-Erms (DE)

(21) Appl. No.: 16/320,315

(22) PCT Filed: Jul. 28, 2017
(86) PCT No.: PCT/EP2017/069175

§ 371 Date: Jan. 24, 2019

(30) Foreign Application Priority Data
Jul. 29, 2016 (DE) 10 2016 114 006.6
Aug. 11, 2016 (DE) 10 2016 114 916.0

(51) Int. Cl. F02M 26/35; B01D 46/42; B01D 46/10; B01D 46/00; F01N 3/022; F01N 3/027; F01N 3/035; F01N 5/02; F01N 9/00; F02M 26/11; F02M 26/45; B01D 46/46

(52) U.S. Cl. CPC F02M 26/35; B01D 2279/30; B01D 46/10; B01D 46/0063; B01D 46/0061; F01N 3/022; F01N 3/027; F01N 3/035; F01N 5/025; F01N 9/002; F02M 26/11; F02M 26/45; B01D 46/46; F01N 2900/0414; F01N 2510/065; F01N 2330/12; B01D 2271/02; B01D 46/4263

(57) ABSTRACT

A sieve seal as a component embodied of one piece, consisting of a seal, which holds a sieve body so that it is enclosed over an inner free cross-sectional area. The present invention also relates to a method for sustained operation of a sieve seal of this kind. In order to provide a remedy in the event of a clogging and/or soot formation and an accumulation of deposits in the sieve seal, it is proposed that the sieve body is embodied for an electric current to flow through at least part of it in such a way that a temperature that is sufficient to eliminate at least significant parts of the deposits is achieved or a corresponding temperature threshold is exceeded.

### FIELD OF THE INVENTION

The present invention relates to a sieve seal for an EGR branch of an internal combustion engine, with the sieve seal being embodied as a one-piece component composed of a seal, which holds a sieve body so that it surrounds the latter over its inner free cross-section. The present invention also relates to a method for sustained operation of a sieve seal of this kind in a carbon particulate-laden fluid stream that is conveyed through an exhaust train of an internal combustion engine.

### BACKGROUND OF THE INVENTION

From the prior art, it is known—for example in the low-pressure and/or high-pressure region of an exhaust system of a motor vehicle that is driven by an internal combustion engine—to insert sieves that span a free cross-sectional area of the exhaust train together with seals or other supports in order to protect sensitive components situated downstream in the flow direction from foreign substances or impurities. Depending on the exhaust temperature, these sieves can be flowed through by solid or gaseous particles and become laden with them. In this connection, all of the components in an exhaust stream must, to the best of the designer's ability, be optimally designed to produce the least amount of back pressure in the overall exhaust system. Various embodiments for such sieve seals are known in particular from WO 2015 014992 A1. In order to prevent possible damage due to the discharge of for example flaking ceramic particles in an exhaust stream from combustion chambers of an internal combustion engine, a sieve seal is provided as protection in a corresponding branch of the exhaust train. Sieve seals of this kind have proven their worth in exhaust gas recirculation or EGR lines.

In known devices of the above-described type, it has now been determined that during operation, a filter in the form of a sieve component or sieve body can become sooted-up with soot buildup and deposits when operated with exposure to very hot exhaust gases in an EGR line, even in temperature ranges below 600° C. This occurrence can lead to a significant rise in back pressure and ultimately even to a failure of the relevant EGR segment due to blockage of the filter. Situations of this kind can particularly occur in a low-pressure EGR branch. In this context, even before the failure of the component or damage to the filter element itself, this process leads to a power loss in the driving internal combustion engine.

The object of the present invention is to create a remedy in the form of a sieve seal and to create a method for sustained operation of a sieve seal of this kind.

### SUMMARY OF THE INVENTION

This object is attained according to the invention in that the sieve part is designed for an electric current to flow through at least part of it in such a way that a temperature of up to approx. 600° C. that is sufficient for thermal elimination of at least significant parts of the deposits is achieved in or on the sieve body or a corresponding temperature threshold is exceeded.

In a preferred embodiment of the invention, the filter element comprises at least one heating wire. Deposits are therefore heated until these regions are burned away in a manner comparable to an incandescent lamp effect.

In one embodiment of the invention, a heating element in the form of a heating wire is woven into the metal weave or is separately applied to it, particularly at a short distance from the metal weave of the sieve part.

Preferably, multiple heating wires are provided in and/or on the sieve body. Separate weft strands or warp strands can be used here selectively by means of a corresponding electrical interconnection. In this context, heating wires generally differ from other wires or from a material of the sieve body by virtue of their electrical resistance.

In a particularly preferred embodiment of the invention, the sieve body or more precisely, an entire weave, meshwork, or knit has current flowing through it at least in the region of a current path and is used as a thermally effective heating fabric; in one embodiment of the invention, at least in the region in which it is fastened in the seal, an insulation is provided to prevent an electrical short-circuiting. Due to the structure of the sieve body, the electrical formation of a narrow path for the electrical current during the heating and numerous contact points within the material of the sieve body through which the fluid stream flows is unlikely. A region that is heated by the flow of current, however, should if possible overlap with regions that are particularly affected by deposits.

In another embodiment of the invention, a current flow is applied by means of a tap of the sieve part through the use of the sealing layer as a second pole or ground potential. This embodiment demonstrates the particular advantage of a maximum current density in the region in which as a rule, the most intense deposits collect and thus a maximum burn-off must be performed.

As a further attainment of the above-stated object, a method for sustained operation of a sieve seal according to the above embodiments is proposed, which is characterized in that a current flow through at least a part of the sieve body is maintained over a time segment Δt in order, through heating of the sieve body, to exceed a temperature threshold of approx. 600° C., above which the soot that has collected on the sieve body is burned away to such a degree that the sieve body once again permits a required amount of fluid exhaust gases to flow through. Through the use of additives such as urea, which is injected into the exhaust path, it is possible to reduce the above-mentioned temperature threshold to approx. 450°-550° C.

In another advantageous modification of the invention, a method is disclosed for controlling the current flow through a sieve seal that is embodied according to the invention using the teaching of the previously unpublished patent application DE 10 2015 110 977.8, whose content is incorporated by reference into the disclosure of the present patent application. In this connection, a thermoelectric generator, TEG, in the vicinity of the sieve part or more precisely, in or on the sieve part is used to detect a clogging based on a powerful temperature gradient. This sensor signal from the TEG is then used to activate the current flow through the sieve part.

According to a preferred modification of the invention, through the use of a catalytic coating, at least in parts of the sieve body, a reduction of said temperature threshold to approx. 350-500° C. is achieved. For details and other embodiments of a catalytic coating of the above-mentioned type, full reference is made to the disclosure of the German patent application DE 10 2016 114 916.0, which for the above-mentioned purpose, discloses a wet chemically applied coating composed of an alkali alloy and/or alkaline earth alloy with exemplary embodiments. This embodiment of the invention proposes an approach that runs counter to the teaching of DE 10 2013 212 733 A1, for example. Thus while saving on additional measuring points and electronics with electrical supply lines and fuel-intensive regenerations of a particulate filter situated upstream that is not laden with soot, no intentional increase in an exhaust gas, temperature to more than approx. 600° C. is caused by corresponding regulating procedures. Instead, the present invention bets on the fact that with significantly lower operating temperatures, particularly in a low-pressure exhaust gas return branch, a combustion of carbon-containing deposits is produced by means of a catalytic coating of the sieve body. Even with only a partial coating of the sieve body, a necessary thermal energy is thus reduced significantly so that a thermal conversion is reliably started automatically and then runs autonomously until the deposits on the A catalytically effective coating of the sieve or sieve body achieves the fact that no additional thermal energy, e.g. through heating of a soot particulate filter connected upstream, has to be introduced into this sieve body in order to achieve an elimination of soot particles.

Preferably, the catalytic coating is constructed on the basis of alkali alloys and/or alkaline earth alloys and has a high abrasion resistance with a high efficiency in the catalytic conversion of organic solids with a combustion activity of less than approx. 400° C. With regard to suitable catalytically active substances and coating methods, reference is made at this juncture to the entirety of the disclosures in EP 2 134 795 B1 and EP 2 393 948 B1.

In any case, a device according to the invention can advantageously be used to perform a regeneration or burn-off of soot that has collected on the sieve body at any desired time through the supply of electrical energy. This procedure is thus in particular no longer limited to fast highway driving with correspondingly high exhaust gas temperatures.

### BRIEF DESCRIPTION OF THE DRAWINGS

Other features and advantages of embodiments according to the invention will be explained in greater detail below with reference to exemplary embodiments based on the drawings. The drawings schematically depict the following:

FIG. 1: shows a sectional view of a first exemplary embodiment using a known sieve seal;

FIG. 2: shows a top view of a known sieve seal according to FIG. 1;

FIG. 3: shows another top view of a known sieve seal according to FIG. 1;

FIG. 4a: shows a detail of a sectional view of another exemplary embodiment with an adaptation of a known sieve seal, and

FIG. 4b: shows a top view of the detail in FIG. 4a.

Throughout the different drawings, elements that are the same are always provided with the same reference numerals.

### DETAILED DESCRIPTION OF THE PREFERRED EMBODIMENTS

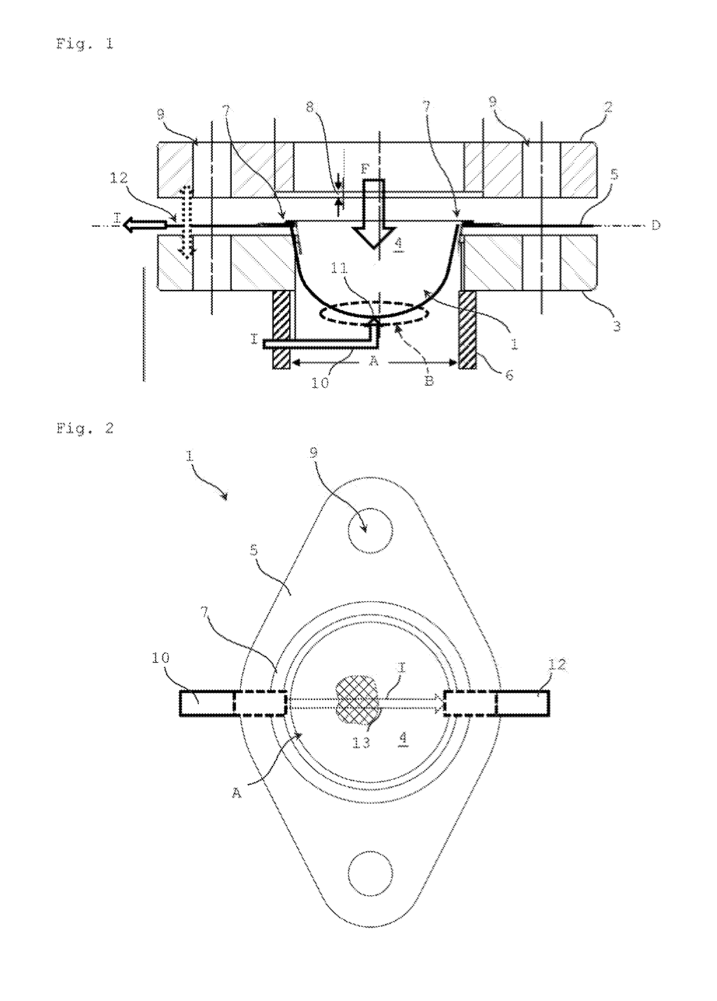

The diagram in FIG. 1 shows a detail of an exhaust gas return, which is not shown in detail, in an exhaust train of a motor vehicle. In order to prevent particles from the exhaust train from penetrating into an internal combustion engine, for example, via the exhaust gas return, a sieve seal 1 is provided in a plane D so as to provide a sealing function between a first flange 2 and a second flange 3, see WO 2015 014992 A1 for details. The sieve seal 1 has a sieve body 4 that is only hinted at here, with a three-dimensional design that is not described in detail below, and a fluid or exhaust gas flows through it in the direction of an arrow F. In the region of the sealing function, the sieve body 4 is fastened with a seal 5 so that gases can travel through the sieve body 4 across the entire free cross-sectional area A of a pipe 6 that adjoins the flange 3. The fastening of the sieve body 4 to the seal 5 takes place in accordance with the disclosure of the European patent application with the application number EP 13178968.7, e.g. by means of a folding that forms an annular bead 7. With regard to the possibilities of the structural embodiment of the sieve body 4, reference is also made to the disclosure of the above-mentioned patent application. In the following exemplary embodiment described hereinafter, it is assumed—without being limited to this—that the sieve body 4 includes a weave or meshwork of metal wires.

In order not to negatively affect the sealing function, in the exemplary embodiment of FIG. 1, a radial recess 8 is provided on the first flange 2. This recess 8 is dimensioned to accommodate the bead 7 so that with the fastening of the flanges 2, 3, by means of openings 9 passing through it, the seal 5 is subjected to an extensive pressing and a sealing action is not based solely on a fastening of the bead 7 between the flanges 2, 3.

A sieve seal 1 of the type described above has proven its value as a protection against the penetration of particles into combustion chambers of an internal combustion engine, which is not shown further, in an exhaust gas return branch or an EGR line of internal combustion engines. It has nevertheless been determined that sieve bodies become sooted-up with soot buildup and deposits when operated with exhaust gas flows in temperature ranges below 600° C. in the EGR line. This occurrence can lead to a significant rise in back pressure and ultimately even to a failure of the relevant EGR segment.

As a solution to this problem, the sieve seal 1 shown in the drawing in FIG. 1 has been enhanced with the addition of an electric supply line 10. This supply line 10 comes into the flange region in a way that is only approximately depicted in FIG. 1 and that is electrically insulated, pressure-tight relative to the outside, and temperature-resistant. In this region, the supply line 10 is provided with a tap 11 as a first pole in a central region of the sieve body 4 for introducing or applying a current flow I. Instead of separate heating wires now being provided, in the exemplary embodiments of the invention described below, a wire material of the sieve body 4 itself is used as the heating wire. A device according to the invention is naturally not limited to the use, for example, of stainless steel wires as heating wires; it is also possible to use metallic wires with a higher specific resistance to produce the sieve body 4.

The sealing layer 5, which is completely insulated electrically from the sieve body 4, in a region that is coated in a non-electrically insulating fashion, constitutes a second pole 12 or a ground potential toward the flanges 2, 3. This avoids an electrical short circuiting and also achieves a distributed current flow I from the tap 11 toward the second pole via the sieve body 4, which leads to a rapid heating of the sieve body 4 in the region of this current flow path 13. In a way that is only schematically indicated here, a bead 7 of the sieve seal 1 and/or the seal 5 itself is formed as a second pole 12 in such a way that it is in electrically conductive contact with the sieve body 4 and also—in an installation position—with at least one of the flanges 2, 3. Because of a virtually point-by-point contacting in the region of the tap 11, the highest current density also occurs there, which consequently also causes a maximum heating in the region that is generally the most strongly affected by accumulations and deposits of soot. It is thus possible to quickly reach a temperature threshold of approx. 600° C.—above which the soot that has accumulated on the sieve body 4 is burned off—and even to exceed this threshold in order to insure the burn-off. After a current flow I is maintained over a time Δt, a sieve body 4 is freed of soot clogs and/or accumulated soot to such an extent that it once again permits a required amount of fluid exhaust gases to flow through.

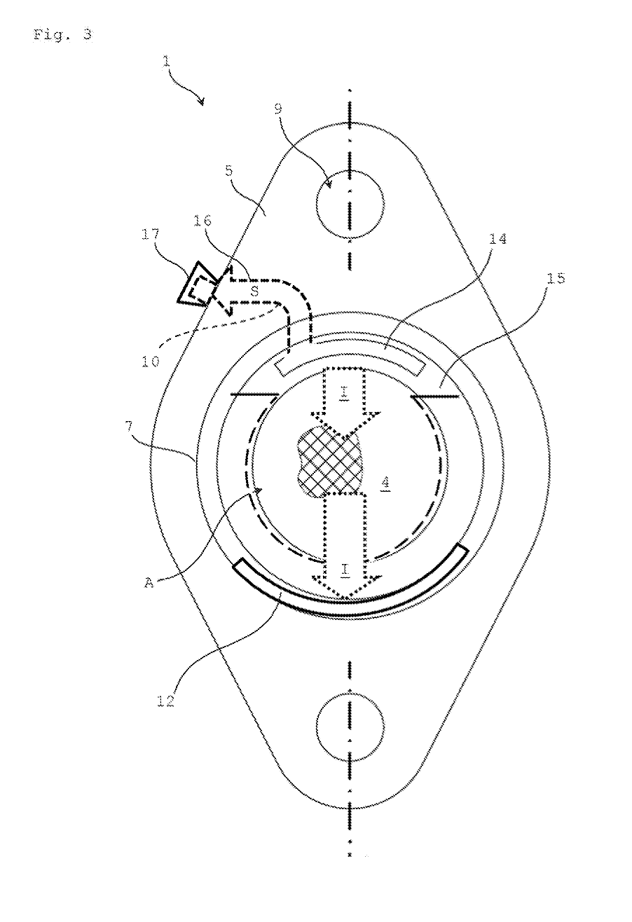

FIG. 2 shows a top view of a version of a known sieve seal 1 according to FIG. 1. In this case, a supply line 10 is provided, which is electrically accessible from the outside and is electrically insulated relative to the seal 5 by means of a partial coating and is connected to the sieve body 4 in an electrically conductive way. This supply line 10 is provided with a second pole 12 opposite from the sieve body 4 and likewise connected to it in an electrically conductive way. In the sieve body 4, depending on the material used and the type of sieve formation, for example separate weft or warp strands are selectively used by means, of a corresponding electrical interconnection. As a result, a current flow can be selectively diverted in a preferred direction, namely to an opposite second pole 12. In this exemplary embodiment, as the shortest connection through the sieve body 4, this yields an indicated current path 13, which in turn passes through a center of the sieve body 4. The current I produces the greatest heating along this current path, which results in a pyrolytic elimination of accumulations or deposits above a temperature threshold of approx. 600° C.

The above-mentioned temperature threshold is at the above-mentioned temperature value unless it can be reduced to approx. 450-550° C. through the addition of additives in the form of a urea injection into the exhaust train or can be reduced to approx. 350° C. bis 500° C. through the use of a catalytic coating on at least parts of the sieve body 4. A partial coating of the sieve body 4 that is produced in a wet chemical fashion by dipping is shown by way of example in a region B in FIG. 1. Since the above-indicated reduction of a starting temperature—referred to as a temperature threshold—for a pyrolytic elimination of carbon-based deposits on or in the sieve body 4 requires only a presence of the relevant catalyst, the region B can be small, a coating can be incomplete, and a quantity of catalyst can turn out to be small. As the catalytically effective material here, alkali alloys and/or alkaline earth alloys are used, which are applied in a wet chemical way in the region B, at least as a partial coating onto the material of the sieve body 4, are pre-dried, and then are baked on. This step can take place by means of printing, spraying, dipping, or dunking, before but also after the formation of the sieve body 4. Even a fully manufactured sieve seal can be correspondingly equipped with a catalytically effective partial coating after the fact.

FIG. 3 shows a top view of another exemplary embodiment using the known sieve seal 1 from the drawings in FIGS. 1 and 2. In this case, a sensor element 14 is placed in the region of the free cross-sectional area A. In order to fasten it securely, a strip or tab 15 made of a metallic sheet is provided, which, as a strip that protrudes into the free cross-sectional area A, serves as a holder for the sensor element 14. The sensor element 14 is embodied as a thermoelectric generator or TEG for short. It has been observed that with progressive clogging of the sieve body 4, a temperature difference occurs between the two outer surfaces of the sieve body 4. This temperature difference causes the TEG to produce a voltage as a sensor output signal S. Based on this sensor output signal S, which is conveyed to an external connection 17 via an internal, separate signal path 16, it is thus possible to indirectly detect a clogging of the sieve body 4. This sensor output signal S can thus be used for externally activating a current I that is to be applied, by also setting a time or time segment Δt for the application of current. In this connection, the application of the current I should achieve a temperature of at least 600° C. in cases in which soot particles have to be burned off from the sieve body 4 by oxidation—when there are none of the forestanding additional measures for reduction of said temperature threshold adopted. For the introduction of the current I, the external connection 17 is electrically connected via the power 10 to the metallic sheet 15, which is in turn connected to the sieve body 4. In a way that is not shown in detail, approximately opposite from the metallic sheet 15, a second pole 12 can in turn be provided in the form of a region of the bead 7 that is not coated in an electrically insulating way, which is electrically connected via the flanges 2, 3 to ground or earth. This once again produces a current path 13 that extends through the sieve body 4.

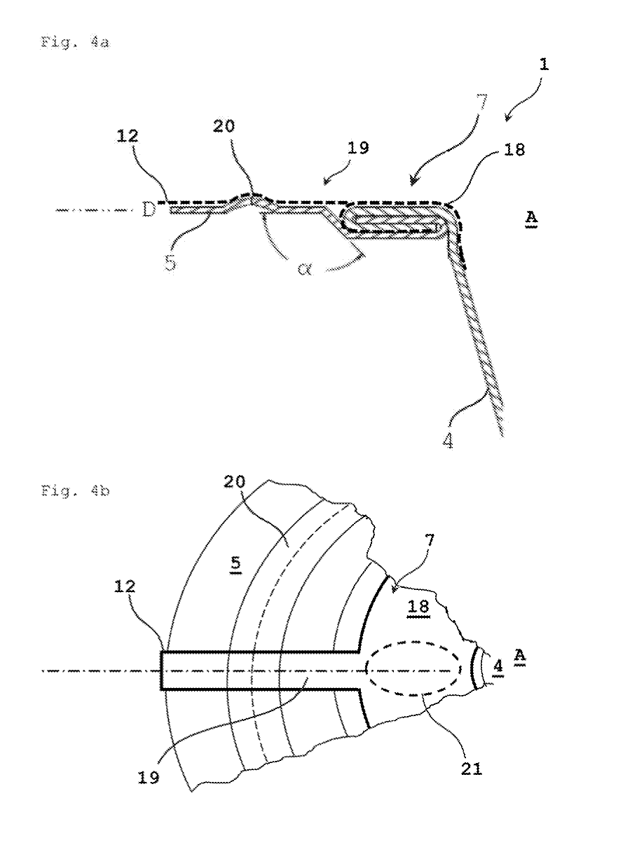

FIG. 4a then shows a detail of a sectional depiction of another exemplary embodiment with an adaptation of the known sieve seal 1 described above. In a modification of the above-described fastening of the sieve body 4 to the seal 5 by means of folding to form the bead 7, in this case a protective ring 18 is provided, which additionally covers the material of the sieve body 4. The protective ring 18 is likewise integrated into the bead 7 by means of folding the materials of the sieve body 4 and the seal 5. In order to mechanically support the material of the sieve body 4, the protective ring 18 extends a short way into the free cross-sectional area A.

The protective ring 18 also has a free arm 19, which extends over a closed sealing bead 20 of the seal 5 into an external connection 10. With an electrical insulation of the sieve body 4 relative to the seal 5, the folding connects the protective ring 18 to the sieve body 4 in an electrically conductive way in a region 21 of the bead 7. As a result, the sieve body 4 can be electrically contacted outside the region of the flanges 2, 3 via the free arm 19 of the protective ring 18 serving as the second pole Or connection. A first pole or connection 11 can, for example, be produced in accordance with the above-described exemplary embodiments of FIGS. 1 through 3.

Finally, FIG. 4b shows a top view of the detail from FIG. 4a in order to show one possible form of a protective ring 18 with a free arm 19, which is connected to the underlying sieve body 4 in an electrically conductive way in the region 21 of the bead 7 in the course of the folding. It is thus possible to apply a current flow I between two poles of the same kind.

Preferred exemplary embodiments for an electrically heatable filter in the form of a sieve body have thus been described above with the emphasis on a use in an EGR branch of a motor vehicle, wherein an integration of the filter into a seal constitutes a simplification of the use and the new feature of being able to be heated, which is available at any time, enables a pyrolytic cleaning of the sieve body that is independent of the current operating state of the engine. At the same time, the seal itself is used to supply and convey away an electrical current or as a support for corresponding supply lines. This therefore yields a compact component with new, very advantageous properties and functionalities.

1. A sieve seal for an EGR branch of an internal combustion engine, the sieve seal, as comprises:
a one-piece component consisting of;
a seal; and
a sieve body positioned so that the sieve body is enclosed over an inner free cross-sectional area of the seal, wherein the sieve body is designed for an electric current to flow through at least part of the sieve body in such a way that a temperature of the sieve body of up to approx. 600° C. that is sufficient for thermal elimination of at least significant parts of deposits in the sieve seal is achieved.

2. The sieve seal according to claim 1, wherein the sieve body includes at least one heating wire.

3. The sieve seal according to claim 2, wherein the at least one heating wire is provided as a heating element in or on the sieve body or is separately mounted at a short distance from the sieve body.

4. The sieve seal according to claim 1, further comprising multiple heating wires provided in, at, and/or on the sieve body.

5. The sieve seal according to one of the preceding claims claim 1, wherein essentially the entire sieve body allows the electric current flow through the sieve body in order to be used as a heating fabric.

6. The sieve seal according to claim 5, wherein a tap of the sieve body for introducing or applying a current flow is provided as a first pole, and at least one region of the seal constitutes a second pole or a ground potential.

7. The sieve seal according to claim 6, wherein a bead of the sieve seal and/or the seal itself is embodied as a second pole in such a way that the bead and/or the seal is in electrically conductive contact with the sieve body and also—in an installation position—with at least one flange.

8. The sieve seal according to claim 1, wherein in or on the sieve body, a TEG element is provided as a sensor for outputting a signal in order to control the current.

9. A method for sustained operation of a sieve seal in an EGR branch of an internal combustion engine according to claim 1, comprising:
maintaining a current flow through at least a part of the sieve body over a time segment in order, through heating of the sieve body, to reach or even exceed a temperature threshold of approx. 600° C., above which soot that has accumulated on the sieve body is burned off to such a degree that the sieve body once again permits a required amount of fluid exhaust gases to flow through.

10. The method according to claim 9, characterized in that further comprising using a TEG element, in or on the sieve body, as a sensor for outputting a signal in order to control the current through at least a part of the sieve body.

11. The method according to claim 10, wherein through the use of additives, the temperature threshold for burning off soot that has accumulated on the sieve body is reduced to approx. 450°-550° C.

12. The method according to claim 9, further comprising using a catalytic coating at least in parts or in a region of the sieve body, and reducing the temperature threshold to approx. 350°-500° C.

13. The method according to claim 12, comprising using alkali alloys and/or alkaline earth alloys as catalytically effective materials.

14. The method according to claim 12, comprising applying a catalytically effective material, at least as a partial coating, to the sieve body in a wet chemical way, pre-drying the coating, and then baking the coating on the sieve body.
